(19) United States
(12) Patent Application Publication
(10) Pub. No.: US 2008/0250795 A1
(43) Pub. Date: Oct. 16, 2008

(54) Air Vaporizer and Its Use in Base-Load LNG Regasification Plant

(75) Inventors: Vidyadhar Y. Katdare, Sugar Land, TX (US); Jeffrey L. Mueller, Richmond, TX (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 11/735,561

(22) Filed: Apr. 16, 2007

(51) Int. Cl. F17C 9/02

(52) U.S. Cl. 62/50.2

(57) ABSTRACT

A system and method for production of gas from a cryogenic fluid using an improved air vaporizer in cyclic production/regeneration modes with a forced air draft and an intermittent heating of ambient air entering the air vaporizer during regeneration mode and/or optionally during the production mode. The system and method may be used in geographical areas where the ambient air temperature can be below freezing. Particularly, the system and method may employ a plurality of these improved air vaporizers for regasification of liquefied natural gas (LNG), particularly for continuous production of natural gas in a base-load LNG regasification plant.

### CROSS-REFERENCE TO RELATED APPLICATIONS

Not Applicable.

### STATEMENT REGARDING FEDERALLY SPONSORED RESEARCH OR DEVELOPMENT

Not applicable.

### TECHNICAL FIELD OF THE INVENTION

This invention relates to an improved air vaporizer for the vaporization of cryogenic fluids and to a method for vaporizing a cryogenic fluid to gas. More specifically, this invention relates to the use of the improved air vaporizer for liquefied natural gas (LNG) regasification, particularly for continuous production of natural gas in a year-round base-load LNG regasification plant using a plurality of the improved air vaporizers in cyclic production/regeneration modes and in all geographical areas, including where the ambient air temperature may be below freezing.

### BACKGROUND OF THE INVENTION

Natural gas is used in many parts of the world as a principal fuel source for the generation of electricity, for industrial applications, as well as for domestic applications such as heating and cooking. Natural gas can also be used as a fuel in internal combustion engines for automobiles and other vehicles. Natural gas is a cleaner burning fuel compared to other fossil fuels, such as coal or oil, and it delivers a given amount of power with lower carbon dioxide emissions. Natural gas is often produced in areas remote from the location where it is utilized. One of the most efficient methods of transporting gas from the production site to consumers is by pipeline. However, when distance and terrain make a pipeline impossible or non-economical, natural gas must be transported by other means. For example, it is common to transport natural gas in its liquefied state, commonly known as liquefied natural gas (LNG). Demand for natural gas is driving efforts to import liquefied natural gas (LNG).

To create LNG, natural gas is cooled in a cryogenic process to a liquid at a temperature from about −260° Fahrenheit (° F.) to about −220° F. LNG must be kept cold by insulation to maintain its liquid state and to minimize evaporation. Because the LNG is denser than natural gas, a significantly greater amount of fuel energy can be transported in a LNG vessel as compared to a pressurized natural gas vessel of equal draft and displacement. LNG is often transported in specially designed vessels aboard very large ships. When the ships arrive at their final destination, the LNG is generally offloaded to storage tanks at a receiving import terminal where the LNG then is processed back into natural gas and then transported through a pipeline to consumers.

A key cost factor for the operations of import terminals is the process of vaporizing LNG into natural gas, which is also known as LNG regasification. Regasification is principally achieved through the transfer of a large amount of heat into the LNG, usually through at least one heat exchanger. Generally, LNG regasification uses at least one of two vaporization methods: one employing open-loop heating or the other employing closed-loop heating with fossil fuel combustion.

In the open-loop heating method, the heat required to vaporize LNG is extracted from a water source at ambient conditions (generally seawater but also possibly water from rivers and/or lakes) using either shell-and-tube heat exchangers or falling-film open rack vaporizers (ORV). Ambient water from this water source is fed to an external rack that allows the water to cascade down the outside of the open rack vaporizer, and the water is collected below the vaporizer prior to being returned to the water source, while LNG typically enters the lower section of the open rack vaporizer and leaves in gaseous form from the top section.

In the closed-loop heating method, heat transfer coils containing LNG are submerged in a water-bath which is heated directly by bubbling (sparging) exhaust gas from a burner through the water, or is heated indirectly via other forms of heat exchange that is offset from the LNG vaporizer, e.g. closed-loop circulation through a shell-and-tube vaporizer. The most common closed-loop system is the sparged water-bath, commonly called a submerged combustion vaporizer (SVC), in which the burner combusts a small fraction of the LNG to produce the heat needed to vaporize the remainder of LNG.

Submerged combustion vaporization and open-rack vaporization are the most common LNG vaporization methods and are both proven, but they also carry high operating costs and environmental-emissions burdens. The SCV method generally spends 1.3 to 1.5% of the generated natural gas, which is a significant operating cost and further generates greenhouse gases such as carbon dioxide. The ORV method must use a large daily amount of ambient water (e.g., hundreds of millions of gallons a day), which may cause a change in ambient water temperature of a few degrees in the vicinity of the effluent discharge of the vaporization unit.

The present regulatory climate is postured to minimize the environmental impacts from LNG import terminals. Thus, the use of ambient air vaporizer (AAV) is gaining interest for LNG regasification, because AAV uses a less expensive heat source (ambient air) for LNG vaporization and avoids the environmental-emissions issues affecting the more common regasification methods employing SCV and/or ORV.

With ambient air vaporization, LNG can be sent through several banks of vaporizers generally comprising extended surface tubular exchangers (similar to those used for nitrogen vaporization at refineries and LNG terminals). Ambient air passes through the outside of the exchangers tubes, and as it is much warmer than the LNG, heat transfer from the air to the LNG occurs and results in the vaporization of LNG as LNG passes through the exchangers tubes. Natural gas is then produced. Air flow through the exchangers can be controlled by two means: natural buoyancy of the cooled denser air or forced convection. Forced convection includes additional costs for power and maintenance. The size and performance of these exchangers is largely affected by the ambient air temperature, humidity and flow rate.

Despite the lower energy demand and reduction of environmental-emissions issues with ambient air vaporization, it may be problematic in achieving a desired exit gas temperature for the produced gas, especially when the ambient temperature is below 0° C. (32° F.) such as during winter months or where the ambient temperature drops to below-freezing temperature during nighttime. In some regasification facilities, ‘trim’ heaters are to be used to increase the temperature of the produced gas (exiting the AAV unit) to a desired gas send-out temperature for a natural gas pipeline, such as for example from 20° F. to 100° F. (from −21° F. to 38° C.). For local distribution, natural gas pipelines can accept a produced gas with a send-out temperature of about 20° F. (−7° C.) or greater. However, for long pipelines, the produced gas flowing there through will be further cooled by the Joule-Thomson effect. Thus, for long-distance natural gas pipelines, the desired send-out gas temperature of the produced gas is generally greater than 20° F. (−7° C.), such as from 40° F. to 90° F. (from 4° C. to 32° C.)

Additionally, because LNG is vaporized by indirect heat transfer against the air, condensed moisture in the ambient air forms a snow-like frost on external surfaces of the exchanger tubes. This frost slowly reduces the vaporizer performance and heat transfer, by reducing the available heat transfer surface. This snow-like frost further hinders the air flow through the exchanger, and tends to form an insulation barrier which prevents the exchanger tubes to warm above ice melting point, i.e., 32° F. (0° C.). Accordingly, the tubular exchanger must be regenerated by terminating the LNG flow in order to melt the built-up ice crystals. To maintain availability of the vaporizer capacity, additional vaporizers must be installed due to regeneration/production cycles. Forced-draft vaporization can be used to reduce the size of the vaporizer and/or the number of additional vaporizers. Moreover, the regeneration/vaporization operation modes (without forced draft device) require significant AAV footprints due to the cyclic nature and due to prevention of ambient air recirculation.

For at least these reasons, AAV technology has been applied for LNG vaporization mainly at peak shaving regasification facilities to supplement open-loop or closed-loop vaporization units (such as SCV or ORV), for the ‘batch’ mode of AAV allows for defrosting time. But scale-up to base-load LNG regasification plants for example at receiving import terminals is unproven, because of the impact of the ambient air conditions on the effectiveness of the AAV and the requirement for periodic defrosting of the AAV to remain operational. As a result, the use of AAV for LNG regasification is currently limited to locations having minimum ambient temperatures not lower than 32° F. (0° C.), generally to tropical and sub-tropical locations.

Thus, air vaporization technology would be very appealing for LNG import terminals if the average exit gas temperature of the produced gas exiting one or more banks of air vaporizers can be maintained throughout the year and/or if the defrosting/production cyclic operation of the one or more banks of air vaporizers can be managed regardless of the ambient air conditions. The present invention addresses these disadvantages and other drawbacks of previous air vaporization systems for the conversion of cryogenic fluid into gas, and particularly for vaporization of LNG to natural gas in base-load LNG regasification facilities.

### SUMMARY OF THE INVENTION

Accordingly, there is provided herein an apparatus for vaporizing a cryogenic fluid to gas that comprises an ambient air heating zone for forming heated air, the ambient air heating zone comprising a heating zone outlet; a regulator device for intermittently operating the heating zone; and an air vaporizer comprising a top end and flow passages for passing a cryogenic fluid therethrough, the top end of the vaporizer being in fluid communication with the heating zone outlet, the flow passages being in heat transfer relation with heated air. The heating zone is disposed upstream (with respect to air flow) of the vaporizer top end, preferably at a higher elevation. The heating zone preferably includes an indirect heat-transfer device with a heat transfer surface which is in contact with moving air. In preferred embodiments, the heating zone and the air vaporizer are air-tight, in order to avoid air leakage in between these units. The flow passages for passing a cryogenic fluid therethrough are preferably pressure rated for a pressure of up to 2,600 psia for the cryogenic fluid flow, preferably for a pressure between 500 psia and 2,600 psia (between 3.4 MPa and 18 MPa).

The regasification apparatus may further comprise a forced draft device for forcibly moving air through the vaporizer. The forced draft device is in fluid communication with the vaporizer and is disposed upstream (with respect to air flow) of the vaporizer top end, preferably at a higher elevation. The forced draft device may comprise at least one unit selected from the group consisting of a fan, a blower, an eductor, an ejector, any plurality thereof, and any combination of two or more thereof.

The heating zone and the forced draft device are connected and in fluid communication. Both of the heating zone and the forced draft device are upstream (with respect to air flow) to the vaporizer air inlet which is generally located at the vaporizer top end. In some embodiments, the heating zone is upstream (with respect to air flow) to the forced draft device. In alternate embodiments, the forced draft device is upstream (with respect to air flow) to the heating zone.

In preferred embodiments, the forced draft device, the heating zone and the air vaporizer are air tight in order to avoid air leakage in between these units.

In some embodiments, the top end of the vaporizer may be contiguous to the air outlet of the heating zone. In alternate embodiments, the top end of the vaporizer may be contiguous to the air outlet of the forced draft device.

The air heating zone, the forced draft device, and the vaporizer may be positioned in serial arrangement for downward air flow in the given order. Alternatively, the forced draft device, the air heating zone and the vaporizer may be in serial arrangement for downward air flow in the given order.

The regulator device may comprise an on-off device or a controller, or combination thereof.

The regulator device may be connected to the heating zone for intermittently operating the heating zone preferably during regeneration mode and optionally during production mode.

The regulator device may be connected to the vaporizer for cyclic operating of the vaporizer between production mode and regeneration mode.

The air vaporizer may further comprise a cryogenic fluid valve for feeding the cryogenic fluid to the vaporizer and a gas valve for exiting the produced gas from the vaporizer. In some embodiments, the regulator device may control the actuation of either valve or both of these valves in a staggered fashion.

Another aspect of the present invention relates to a regasification plant comprising a plurality of regasification units, each regasification unit comprising an air vaporizer having flow passages for passing a cryogenic fluid therethrough and an ambient air heating zone located upstream of the air vaporizer (with respect to air flow). A first subset of the plurality of the regasification units is in a production mode, while a second subset of the plurality of the regasification units is in a regeneration mode. Preferably, each regasification unit comprises any of the various embodiments of the regasification apparatus as described above.

Yet another aspect of the present invention relates to a method for converting a cryogenic fluid to gas, comprising the steps of: (a) moving air in a downward manner through the vaporizer, the moved air externally contacting the flow passages and being in heat transfer relation with the flow passages; (b) passing the cryogenic fluid through the flow passages of the vaporizer to vaporize the cryogenic fluid and to generate a gas; (c) discontinuing step (b); (d) carrying out step (a) with a forced air draft; and (e) heating ambient air having a first temperature to form heated air having a second temperature, the step (e) being carrying out before the heated air moves through the vaporizer. The method may further comprise carrying out the air heating step (e) while carrying out the air moving step (a) and the cryogenic fluid passing step (b) to produce a gas.

Operating the air vaporizer in production mode preferably comprises carrying out steps (a) and (b) simultaneously. Operating the air vaporizer in regeneration mode preferably comprises carrying out steps (c), (d) and (e).

An additional aspect of the present invention relates to a method for converting cryogenic fluid to gas in a regasification plant comprising a plurality of regasification units, each regasification unit comprising an air vaporizer having flow passages for passing the cryogenic fluid therethrough and an ambient air heating zone located upstream of the air vaporizer (with respect to air flow). Preferably, each regasification unit comprises any of the various embodiments of the regasification apparatus described therein. Such method comprises operating a first subset of the plurality of the regasification units in a production mode, and operating a second subset of the plurality of the regasification units in a regeneration mode. The production mode for each regasification unit in the first subset comprises carrying out the following steps: (a) moving air in a downward manner through the vaporizer, wherein the moved air externally contacts the flow passages and is in heat transfer relation with the flow passages; and (b) passing the cryogenic fluid through the flow passages of the vaporizer to vaporize the cryogenic fluid and to generate a gas The regeneration mode for each regasification unit in the second subset comprises the following steps: (c) not passing the cryogenic fluid through the flow passages of the vaporizer; (d) moving air in a downward manner with a forced air draft through the vaporizer, wherein the moved air externally contacts the flow passages and is in heat transfer relation with the flow passages; and (e) heating ambient air having a first temperature to form heated air having a second temperature, the step (e) being carrying out before the heated air is forcibly moved through the vaporizer.

When one regasification unit in production mode produces in step (b) a gas having an exit gas temperature lower than a predetermined value, the air vaporizer may be switched to a regeneration mode by performing steps (c), (d) and (e). Alternatively or additionally, when one regasification unit in production mode produces in step (b) a cooled air exiting the vaporizer having a temperature which differs (in absolute value) from that of the air entering the vaporizer by less than a minimum temperature gap, e.g., a gap of 10° F. (gap of 5.5° C.), the air vaporizer may be switched to regeneration mode by performing steps (c), (d) and (e). Step (c) can be initiated by discontinuing step (b). Step (d) can be initiated by turning on a forced draft device such as fan(s) or blower(s) to generate a forced air draft. Step (e) may be initiated when the ambient air does not meet certain criteria of temperature and/or moisture content for example.

The method for converting cryogenic fluid to gas may further include the following embodiments, either separately or in any combination.

The air moving step (a) may comprise moving the air with a forced draft in a downward manner through the vaporizer.

It is preferred to heat the air which enters the air vaporizer during the vaporizer regeneration mode (to provide defrosting), especially when the ambient air temperature is at or below a pre-selected value, such as from 32° F. to 50° F. (from 0° C. to 10° C.). Additionally or alternatively, heating the ambient air which enters the air vaporizer may be carried out during the vaporizer production mode, for example in order to enhance the vaporizer efficiency and/or improve its capacity, such as in instances when the ambient air temperature is at or below the pre-selected value, or when the exit gas temperature does not meet a predetermined value, or when the flow rate of the produced gas needs to be increased.

The generated gas produced during production mode (i.e., steps (a) and (b)) has an exit gas temperature equal to or more than a predetermined exit gas temperature. The predetermined exit gas temperature of the generated gas exiting the vaporizer may be between −60° F. and 100° F. (between −51° C. and 38° C.).

The run time for the regeneration mode may be carried out for about a fourth to half of the run time for the production mode.

Steps (a) and (b) may be carried out for a run time between 1 and 24 hours. Steps (c), (d) and (e) may be carried out for a run time between 0.25 and 12 hours.

Step (b) for passing the cryogenic fluid in production mode can be performed at a cryogenic fluid pressure up to 2,600 psia, preferably at a cryogenic fluid pressure between 500 psia and 2,600 psia (between 3.4 MPa and 18 MPa).

While steps (a) and (b) are performed, a frost is deposited externally on the flow passages. Steps (c), (d) and (e) can then be performed to allow defrosting of the flow passages, when one or more criteria are not met, such as when the exit gas temperature is below a predetermined value, and /or the ice thickness on the vaporizer flow passages is above a threshold value.

Step (c) may be carried out (that is to say, step (b) is terminated) to initiate the regeneration mode, when the exit gas temperature is less than a predetermined exit gas temperature. Alternatively, step (c) may be carried out to initiate the regeneration mode when the difference (in absolute value) between the temperature of the air entering the vaporizer and the temperature of the air exiting the vaporizer is less than a minimum temperature gap. The air third temperature may differ from the air first temperature or from the air second temperature by at least a minimum temperature gap, such as a gap of 10° F. (5.5° C.) or more.

The heating step (e) may be carried out during regeneration mode (i.e., at the same time as steps (c) and (d)) when the ambient air first temperature is less than a pre-selected first temperature. Alternatively or additionally, the heating step (e) may be carried out during regeneration mode to maintain the air second temperature at or above a pre-selected second temperature, such as ranging from 50° F. to 68° F. (from 10° C. to 20° C.).

The heating step (e) may be further carried out during production mode (i.e., at the same time as steps (a) and (b)), to enhance the vaporizer efficiency and/or to improve the vaporizer capacity, for example when the exit gas temperature is less than a predetermined exit gas temperature. Alternatively or additionally, the heating step (e) may be carried out during production mode to maintain the air second temperature at or above a pre-selected second temperature, such as ranging from −4° F. to 68° F. (from −20° C. to 20° C.).

The heating step (e) may comprise (e1) heating of the ambient air when the air first temperature is less than a pre-selected first temperature, such as ranging from 32° F. to 50° F. (from 0° C. to 10° C.), to achieve a second temperature greater than the first temperature.

The heating step (e) may comprise (e2) discontinuing heating of the ambient air when the first temperature is equal to or greater than the above-mentioned pre-selected first temperature or another pre-selected first temperature, such as ranging from 33° F. to 50° F. (from 1° C. to 10° C.).

In preferred embodiments of the present invention, the apparatus, method and process for vaporizing cryogenic fluid into gas are applicable to the liquefied natural gas (LNG) regasification in which the cryogenic fluid is liquefied natural gas.

The present invention enables the practical use of air vaporizers in a wider range of weather conditions and geographical locations for LNG regasification plants. The use of a plurality of such improved regasification units can be suitable in base-load LNG regasification facilities, as the regeneration mode (e.g., defrosting) can be efficiently carried out regardless of the ambient air conditions, by heating (when needed in an intermittent fashion) the ambient air entering the air vaporizer for effective defrosting. Indeed, during defrosting of the air vaporizer, the intermittent heating of the ambient air entering the air vaporizer allows for a much reduced regeneration run time, thus requiring less off-duty regasification units in the base-load regasification LNG plant. With ambient air heating, defrosting can still be carried out even when the ambient temperature is less than the ice melting point, which would not be possible otherwise with commercially available ambient air vaporizers. Additionally, the efficiency of the improved regasification unit can be enhanced during production mode by either intermittently or continuously heating of the ambient air before it enters the vaporizer of the regasification unit.

Thus, the various embodiments of the present invention comprise one or more combinations of features and advantages which enable them to overcome various problems of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of the preferred embodiments of the present invention, reference will now be made to the accompanying drawings, wherein:

FIG. 1 represents an embodiment of a regasification apparatus comprising a natural draft air vaporizer with an air heating zone according to the present invention;

FIG. 2 represents another embodiment of a regasification apparatus comprising a forced draft air vaporizer with an air heating zone and a forced draft device according to the present invention;

FIG. 3 represents yet another embodiment of a regasification apparatus comprising a forced draft air vaporizer with an air heating zone and a forced draft device according to the present invention;

FIG. 4 represents an alternate embodiment of a regasification apparatus comprising two air vaporizers with their respective air heating zones and forced draft devices and a single regulator device according to the present invention;

FIG. 5 represents another embodiment of a regasification apparatus comprising an air vaporizer with an air heating zone and a regulator device according to the present invention;

FIG. 6 represents another embodiment of a regasification apparatus comprising an air vaporizer with an air heating zone and two regulator devices according to the present invention; and

FIG. 7 represents a schematic of a LNG regasification plant according to the present invention, the plant comprising a plurality of regasification units comprising improved air vaporizers according to the present invention, a subset of which is in production mode, while another subset is in regeneration mode.

### DETAILED DESCRIPTION OF THE PREFERRED EMBODIMENTS

The present invention relates to processes for the vaporization of cryogenic fluid to gas, particularly to regasification of liquefied natural gas, and is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein.

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

It is to be fully recognized that the different teachings of the embodiments discussed below may be employed separately or in any suitable combination to produce desired results.

The preferred use of the following apparatus in the appended drawings is the regasification of LNG. The remainder of the detailed description will focus on this preferred embodiment with the understanding that the present invention may have broader applications.

Ambient-air vaporizers can be used to vaporize a cryogenic fluid, such as liquefied natural gas prior to releasing the produced gas to a downstream operation or a pipeline.

In particular, for LNG regasification, the geographic location of the regasification plant must be considered due to different ambient air conditions. For purposes of example only, and not by way of limiting the scope of the invention in any way, the present invention will be described as a process to regasify liquefied natural gas (LNG) that is located at a regasification plant in which the average ambient temperature does not typically fall below −10° F. (−23° C.). Additionally, the regasification plant can be located by a shoreline or on an offshore facility, for easy offloading from LNG tankers or offshore LNG pipeline. The temperatures and pressures stated hereinafter are for exemplary purposes.

The present invention allows the use of air vaporizers to be practical for vaporization of cryogenic fluid in a wider range of weather conditions and geographical locations.

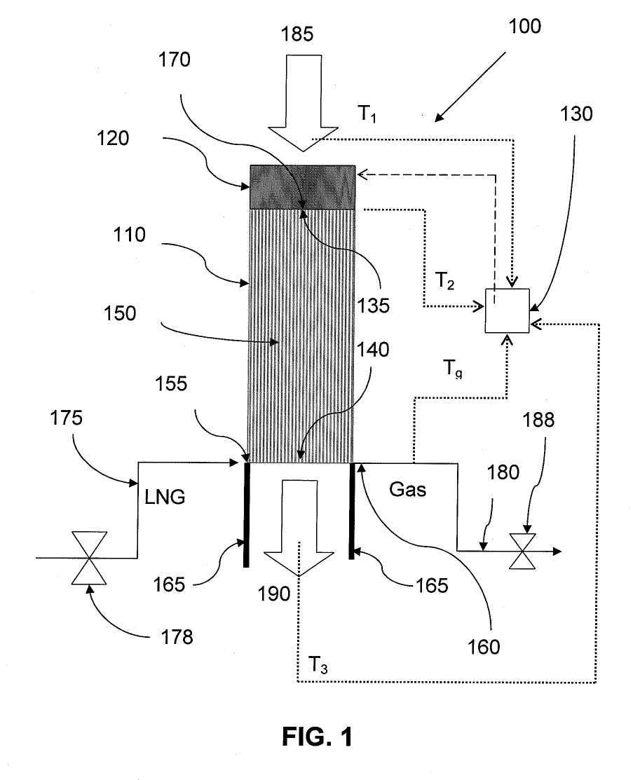

FIG. 1-3 illustrate various embodiments of a regasification apparatus (100; 200; 300) for vaporizing cryogenic fluid (e.g., LNG) to gas according to the present invention.

Each of the regasification apparatus (100; 200; 300) in FIG. 1, 2 and 3, respectively, comprises an air vaporizer (110; 210; 310), a heating zone for heating ambient air (120; 220; 320), and a regulator device (130; 230; 330).

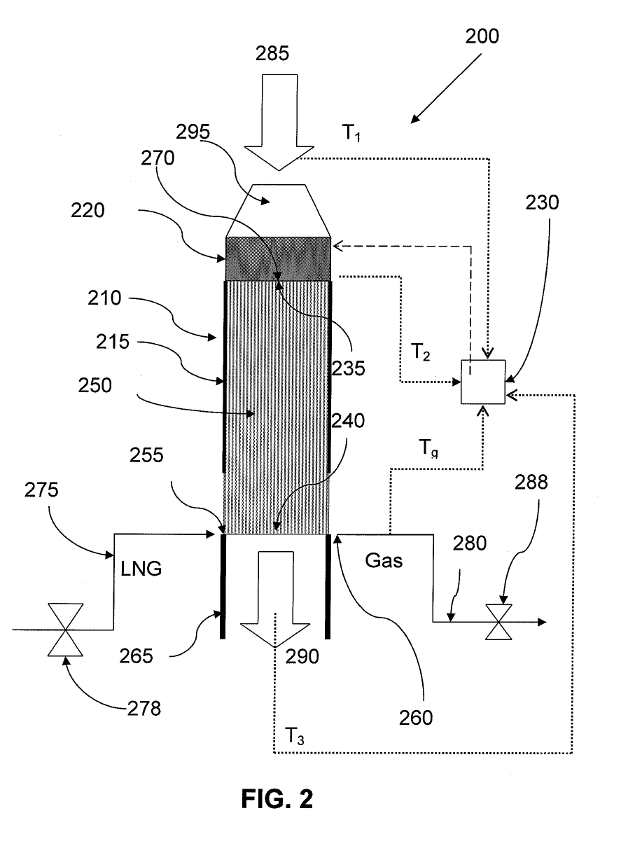

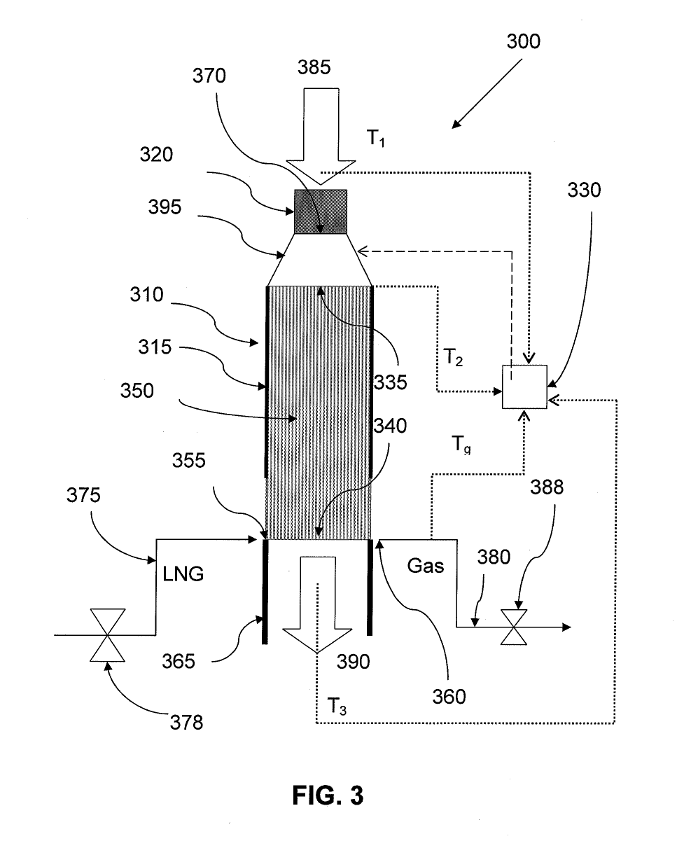

The regasification apparatus (100) of FIG. 1 comprises a natural draft air vaporizer, while the regasification apparatus (200) in FIG. 2 and (300) in FIG. 3 comprise a forced draft air vaporizer.

FIG. 3 differs from FIG. 2 in the position of the forced draft device with respect to the heating zone. In FIG. 2, the forced draft device (295) is positioned upstream (with respect to the air flow) of the heating zone (220), which is itself positioned upstream (with respect to the air flow) of the vaporizer (210). When the forced draft device (295) is disposed above the heating zone (220), there is a forced air draft through both the heating zone (220) and the vaporizer (210). Alternatively, in FIG. 3, the forced draft device (395) is positioned downstream (with respect to the air flow) of the heating zone (320), while still being positioned upstream (with respect to the air flow) of the vaporizer (310). When the forced draft device (395) is disposed between the heating zone (320) and the vaporizer (310), there is an induced air draft through the heating zone (320) and a forced air draft through the vaporizer (310).

The descriptions of the air vaporizer (110; 210; 310), the heating zone (120; 220; 320) and the regulator device (130; 230; 330) which follow are applicable to all embodiments of the present invention.

Air vaporizer (110; 210; 310) may comprise any commercially available ambient air vaporizer, also commonly known as ‘AAV’. A preferred air vaporizer is a vertical air vaporizer. Air vaporizer (310) combined with the forced draft device (395) may comprise any commercially available forced-air vaporizer, such as a vertical forced-air fan-assisted vaporizer. Suitable ambient air vaporizers are commercially available for example from Cryoquip Incorporated, Thermax Incorporated, and Linde.

Generally, the air vaporizer (110; 210; 310) comprises a top end (135; 235; 335) and a bottom end (140; 240; 340). The air vaporizer (110; 210; 310) is preferably vertically extended with its height greater than its width.

Air vaporizer (110; 210; 310) has an air inlet typically disposed at or near the top end (135 235; 335) of the vaporizer (110; 210; 310), and an air outlet typically disposed at or near the bottom end (140; 240; 340) of the vaporizer (110; 210; 310). In preferred embodiments, the top end (135; 235; 335) of the vaporizer (110; 210; 310) is the vaporizer air inlet; and the bottom end (140; 240; 340) of the vaporizer (110; 210; 310) is the vaporizer air outlet.

The flow of air through the air vaporizer (110; 210; 310) is generally in a downward manner from the vaporizer top end (135; 235; 335) to the vaporizer bottom end (140; 240; 340).

The air vaporizer (110; 210; 3 10). preferably comprises one or more flow passages (150; 250; 350) such as conduits, pipes, coil or tubes, any plurality thereof, or any combinations thereof. Generally, flow passages (150; 250; 350) are vertically positioned, piped together and disposed between top and bottom ends of the vaporizer (110; 210; 310). The flow passages (150; 250; 350) may be comprised of a center tube through which the cryogenic fluid passes. The flow passages (150; 250; 350) may be interconnected alternately top to top and bottom to bottom via “U” shaped connecting pipes (not shown). The flow passages (150; 250; 350) preferably have longitudinally placed heat exchange surfaces or fins (not shown) with adjacent conduits being approximately equally spaced from one another in a generally rectangular array. The presence of heat exchange surfaces or fins enhances the surface area for heat transfer and thus increases the heating capacity of the vaporizer (110; 210; 310).

The flow passages (150; 250; 350) are pressure rated up to 2,600 psia (up to 18 MPa) to allow the passing of the cryogenic fluid (175; 275; 375) therethrough, preferably pressure rated for a pressure between 500 psia and 2,600 psia (between 3.4 MPa and 18 MPa).

The flow passages (150; 250; 350) preferably have a cryogenic inlet (155; 255; 355) located at the bottom end (140; 240; 340) of the vaporizer (110; 210; 310). The flow passages (150; 250; 350) preferably have a gas outlet (160; 260; 360). Although the gas outlet (160; 260; 360) is shown in FIG. 1-3 disposed near or at the vaporizer bottom end (140; 240; 340), it should be understood that the gas outlet (160; 260; 360) may be disposed near or at the vaporizer top end (135; 235; 335), for example in the case of a unidirectional vaporizer with cryogenic fluid upward flow. For bi-directional (up-and-downs) setup, the cryogenic fluid may pass from one flow passage through a connection to the top of another passage through which it descends. This flow pattern may be repeated through other passes as conditions such as usage and ambient temperature dictate. Several cryogenic inlets (155; 255; 355) may be connected by a manifold which distributes the cryogenic fluid from a main cryogenic fluid source to the flow passages (150; 250; 350). Similarly, several gas outlets (160; 260; 360) may be connected by a manifold which collects various exiting produced gas streams from the flow passages (150; 250; 350) to send it to further downstream processing or to a pipeline.

For bi-directional (up-and-downs) setup for the cryogenic fluid, since the flow of air through the air vaporizer (110; 210; 310) is generally in a downward manner, the fluid flow of air and cryogenic fluid through the air vaporizer (110; 210; 310) is generally termed ‘mixed flow’ (that is to say, both co-current and countercurrent). For unidirectional (upflow) setup for the cryogenic fluid, since the flow of air through the air vaporizer (110; 210; 310) is generally in a downward manner, the fluid flow of air and cryogenic fluid through the air vaporizer (110; 210; 310) is generally termed ‘countercurrent flow’ configuration. The preferred flow configuration of air vaporizer (110; 210; 310) is mixed-flow; but countercurrent flow is also an acceptable configuration.

The air vaporizer (110; 210; 310) is generally operated at or about atmospheric pressure for air flow. Furthermore, the air vaporizer (110; 210; 310) is preferably operated at high pressure between 500 psia and 2,600 psia ((between 3.4 MPa and 18 MPa) for cryogenic fluid flow in the flow passages (150; 250; 350).

The air vaporizer (110; 210; 310) is generally supported by legs (165; 265; 365) affixed to the ground or to a platform. The spacing between the bottom end (140; 240; 340) of the vaporizer (110; 210; 310) and the ground or platform has sufficient clearance to allow for air movement below the vaporizer (110; 210; 310).

The air vaporizer (110; 210; 310) may comprise vertically extended walls (illustrated as walls 215 and 315 on FIG. 2 and 3). These vertically extended walls encircle or surround the flow passages (150; 250; 350). The function of these vertically extended walls is to control the direction of air flowing through the air vaporizer (110; 210; 310) in a generally vertical manner, with minimal radial air flow in order to prevent air escaping from the outskirt of the vaporizer (110; 210; 310). These vertically extended walls should not hinder air flow from the vaporizer top end (135; 235; 335) to its bottom end (140; 240; 340), but provide more control on the direction of air flow.

The vertically extended walls can extend from the top end (135; 235; 335) to the bottom end (140; 240; 340) of the vaporizer (110; 210; 310); but could extend from the top end (135; 235; 335) to any elevation above the vaporizer bottom end (140; 240; 340). For example, vertically extended walls may extend from the vaporizer top end down to half or more of the height of the vaporizer (110; 210; 310), where the vaporizer height can be measured in a vertical direction from its air inlet at the top end (135; 235; 335) to its air outlet in the bottom end (140; 240; 340).

Alternatively (although not illustrated), vertically extended walls may extend from an elevation upwards of the vaporizer top end (135; 235; 335) to further encircle or surround the heating zone (120; 220; 320 in FIG. 1-3) and/or the forced draft device (295; 395 in FIG. 2-3).

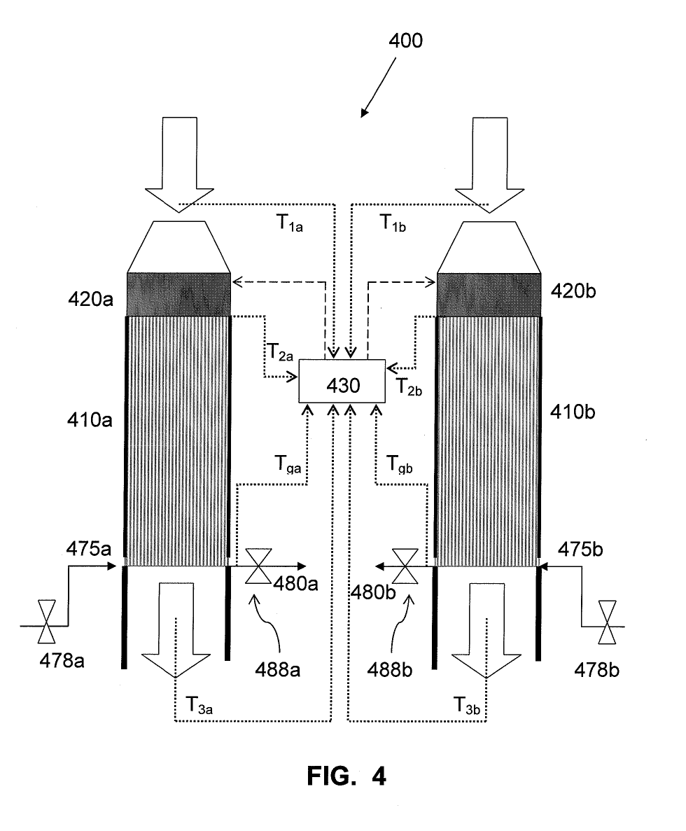

Vertically extended walls are preferably used for a vaporizer with forced air draft, such as for vaporizer 210 in FIG. 2, vaporizer 310 in FIG. 3, and vaporizers 410a & 410b in FIG. 4. As illustrated in FIG. 2 and 3, walls 215 or 315 may extend from the top end (235; 335) elevation down to an elevation between half of the height of the vaporizer (210; 310) and the bottom end (240; 340) of the vaporizer (210; 310). Similarly, as illustrated in FIG. 4, enclosing walls may extend from the top end elevation of each vaporizer (410a; 410b) to an elevation slightly above the bottom end of the vaporizer (410a; 410b).

Heating zone (120; 220; 320) is in fluid communication with the vaporizer (110; 210; 310). The heating zone (120; 220; 320) and the vaporizer (110; 210; 310) are fluidly connected in order for the vaporizer (110; 210; 310) to receive most of (preferably all of) the air exiting the heating zone (120; 220; 320).

Heating zone (120; 220; 320) is disposed upstream (with respect to air flow) of the top end (135; 235; 335) of the vaporizer (110; 210; 310). Heating zone (120; 220; 320) is preferably positioned at a higher elevation than the top end (135; 235; 335) of the vaporizer (110; 210; 310). Heating zone (120; 220; 320) is more preferably positioned above the top end (135; 235; 335) of the vaporizer (110; 210; 310).

In preferred embodiments, the heating zone (120; 220; 320) and the air vaporizer (110; 210; 310) are air tight in order to avoid air leakage in between these two units.

Heating zone (120; 220; 320) further comprises an air inlet through which air enters the heating zone (120; 220; 320) and an air outlet (170; 270; 370) through which air exits the heating zone (120; 220; 320).

In some embodiments, illustrated by FIG. 1 and 2, the vaporizer top end (135; 235) and the heating zone air outlet (170; 270) are contiguous. In such case, the air outlet (170; 270) of the heating zone (120; 220) and the air inlet of the vaporizer (110; 210) are closely-spaced aligned to allow all of the air flowing out of the heating zone (120; 220) to directly enter the vaporizer (110; 210).

Heating zone (120; 220; 320) may comprise any indirect heat-transfer device with a heat transfer surface which is in contact with ambient air. Heating zone (120; 220; 320) may comprise at least one heating element selected from the group consisting of a band heater, an electric resistance heater, a steam heater, a fired heater, a heating coil, a tube-and-shell unit, any plurality thereof, and combinations of two or more thereof. In preferred embodiments, the heating zone (120; 220; 320) may comprise an electric resistance heater, a plurality thereof, a heating coil, a plurality thereof, or combinations thereof. A heat transfer medium may pass inside a heating coil or a shell-and-tube heater, and may comprise steam, water, oil, glycol or any other commercially available heat transfer fluid, such as Dowther®, Syltherm®, at a temperature sufficient to allow proper heat transfer between the heat transfer medium and air passing through the heating zone (120; 220; 320).

One of the functions of the heating zone (120; 220; 320) is to maintain the air second temperature T₂ at or above a pre-selected air second temperature T₂^{s}. The heating zone may be operational during regeneration mode of the vaporizer (110; 210; 310) to enhance defrosting of the vaporizer (110; 210; 310), for example when certain criteria of ambient air conditions are met. Optionally, the heating zone (120; 220; 320) may be operational during production mode to enhance the vaporizer capacity or increase the vaporizer efficiency.

When the heating zone (120; 220; 320) comprises a heating coil or a shell-and-tube heater, the temperature of the heat transfer medium may be at least 10° F. (5.5° C.) greater, preferably, at least 15° F. (8.3° C.) greater, than the pre-selected air second temperature T₂^{s}. Alternatively, the temperature of the heat transfer medium may be between 10° F. and 15° F. higher (between 5.5° C. and 8.3° C. higher) than the pre-selected air second temperature T₂^{s}.

Although not illustrated in FIG. 1-3, it is to be understood that the use of a plurality of heating zones is envisioned. The plurality of heating zones may comprise the same heating element, or may comprise different heating elements. The plurality of heating zones may be operated in parallel. For example, the plurality of heating zones may be disposed at a higher but similar elevation than the vaporizer top end (135; 235; 335). Alternatively, the plurality of heating zones may be operated in series, that is to say, there are several heating zones disposed above the vaporizer top end (135; 235; 335), but at different elevations. The plurality of heating zones would still function as heating the air before it enters and flows through the vaporizer (110; 210; 310). In preferred embodiments, the plurality of the heating zones and the vaporizer are air tight to avoid air leakage in between these units.

Regulator device (130; 230; 330) may comprise an on-off electrical switch, a rheostat, a single-speed pump, a variable-speed pump, a valve, a controller, or combinations of two or more thereof. A rheostat is a resistor designed to allow variation in resistance without breaking the electrical circuit of which it is a part.

In some embodiments, the regulator device (130; 230; 330) may comprise a gate valve, a butterfly valve, a globe valve or a needle valve, which can gradually open or close for changing the heating output of the heating zone (120; 220; 320), for example by changing the flow rate of a heat transfer medium flowing though a heating coil or shell-and-tube heater in the heating zone (120; 220; 320). In alternate embodiments, the regulator device (130; 230; 330) may comprise an off-on valve, such as a ball valve, which either opens or closes for resuming or stopping the flow of a heat transfer medium flowing though a heating coil or shell-and-tube heater.

The regulator device (130; 230; 330) may receive outputs from monitoring analyzers (not shown) such as temperature sensor, flow meter rotameter, humidity sensor, and the like. These monitoring analyzers can measure on-line some characteristics of the ambient air, of the air exiting the heating zone or entering the vaporizer, of the cooled air exiting the vaporizer, and/or of the gas exiting the vaporizer. Such monitoring analyzers may measure variables such as for example air temperature, air humidity content, volumetric flow rate and/or mass flow rate at one or more locations in the apparatus (100; 200; 300).

The regulator device (130; 230; 330) may be manually controlled or automatically controlled. Manual control is generally effected by a person who monitors instrument readout of an output variable (e.g., temperature, flow rate, frost thickness on flow passages, extent of frost coverage on external surfaces of the flow passages) and decides whether to actuate the regulator device (130; 230; 330), such as in ‘on’ or ‘off’ positions, alternatively in a ‘more’ or ‘less’ positions. Automatic control can be achieved by a feedback controller. In this case, an output variable measured by an analyzer is sent to a feedback controller when the measured output is compared to a setpoint value. Based on the deviation between setpoint and measured values, control action is determined by some control algorithm. Simple automatic control is on-off control. The regulator device (130; 230; 330) may be turned on when the deviation between setpoint and measured values exceeds a specific threshold deviation, and turned off when the deviation between the setpoint and measured values exceeds a threshold gap, or vice versa. When the regulator device (130; 230; 330) can act physically on the operation of the heating zone (120; 220; 320) to cause corrective action, on-off control of the regulator device (130; 230; 330) can be done with an on-off device, such as a single-speed pump or an electrical on-off switch. When the regulator device (130; 230; 330) provides a continuous range of output(s), such as a variable-speed pump or an electrical rheostat, automatic control of the regulator device (130; 230; 330) may comprise proportional-integral (PI) or proportional-integral-derivative (PID) control.

In preferred embodiments, the regulator device (130; 230; 330) may comprise a controller. The controller may be a pneumatic, electronic or digital computer device. The controller is preferably a feedback controller. The feedback controller may be an on-off controller, a proportional-integral (PI) controller or proportional-integral-derivative (PID) controller. A single computer may be used as the controller for one or more single-variable feedback control loops. One of the advantages of using a computer as the controller is the opportunity to combine the data analysis capabilities of the computer with the flexibility of manipulating more than one process variables to achieve control. For example, measurements of several variables, such as ambient air temperature T₁, temperature T₂ of the air exiting the heating zone and entering the vaporizer, temperature T₃ of the air exiting the vaporizer, and exit gas temperature T_{g} may allow for on-line estimation of differences in some of these temperatures in absolute values (such as |T₂−T₁|, |T₃−T₁| or |T₃−T₂|) and the heat transfer rates in the heating zone and in the vaporizer. The communication between analyzer(s) and controller may require a Digital/Analog converter, a Voltage/Intensity converter, or a relay. An example where a single regulator device (430) can direct the operation of two heating zones connected to their respective vaporizers, is illustrated in FIG. 4, and will be described later.

A valve (188; 288; 388) on the produced gas line (180; 280; 380), hereinafter called ‘gas valve’, can be used to regulate the flow of the produced gas (180: 280; 380) exiting the vaporizer (110: 210; 330). Gas valve (188; 288; 388) can be any valve suitable for adjusting/stopping the flow of the produced gas (180: 280; 380), and is made of material able to sustain the temperature and pressure of the produced gas (180: 280; 380). Valve (188; 288; 388) may be an off-on valve or any valve which can gradually open or close for adjusting the flow rate of the produced gas (180: 280; 380). Although not illustrated, the gas valve (188; 288; 388) may be connected to the regulator device (130; 230; 330), which can direct its actuation, such as its opening or closing.

A (valve (178: 278; 378) on the cryogenic fluid line (175: 275; 375), hereinafter called ‘cryogenic fluid valve’ can be used to regulate the flow of the cryogenic fluid (175: 275; 375) fed to the vaporizer (110: 210; 330). Cryogenic fluid valve (178: 278; 378) can be any valve suitable for adjusting/stopping the flow of a cryogenic fluid (such as LNG), and is made of material able to sustain the temperature and pressure of the cryogenic fluid (175: 275; 375). Cryogenic fluid valve (178: 278; 378) may be an off-on valve, a three-way valve, or any valve which can gradually open or close for adjusting the flow rate of the cryogenic fluid (175; 275; 375). Although not illustrated, the cryogenic fluid valve (178; 278; 378) may be connected to the regulator device (130; 230; 330), which can direct its actuation, such as its opening or closing.

The regasification apparatus for vaporizing cryogenic fluid to gas (apparatus 200; 300 of FIG. 2 and 3 respectively) may further comprise a forced draft device (295; 395) for forcibly moving air through the vaporizer (210; 310). The forced draft device (295; 395) provides a forced air draft through the vaporizer (210; 310). The forced draft device (295; 395) is positioned upstream (with respected to air flow) of the vaporizer top end (235; 335). The forced draft device (295; 395) is preferably disposed at a higher elevation than the vaporizer top end (235; 335), more preferably disposed above the vaporizer top end (235; 335).

The forced draft device (295; 395) may comprise one or more of the following units: a fan, a blower, an eductor, an ejector, any plurality thereof, or any combination of two or more thereof.

In preferred embodiments, the forced draft device (295; 395) and the heating zone (220; 320) are contiguous.

In alternate or additional preferred embodiments, the forced draft device (295; 395), the heating zone (220; 320), and the vaporizer (210; 310) are air tight to avoid air leakage in between these three units.

FIG. 2 and FIG.3 differ in the position of the forced draft device (295; 395) with respect to the heating zone (220; 320).

The regasification apparatus (200) of FIG. 2 illustrates the positioning of the forced draft device (295) upstream (with respect to the air flow) of the heating zone (220). In this case, the forced draft device (295), the heating zone (220) and the vaporizer (210) are in serial air flow arrangement in the given order. In some embodiments, the forced draft device (295), the heating zone (220), and the vaporizer (210) are stacked in serial vertical arrangement, with the forced draft device (295) being on top of the stacking arrangement, and the vaporizer (210) being at the bottom of the stacking arrangement.

In some embodiments, the forced draft device (295) is disposed at a higher elevation than the heating zone (220). The forced draft device (295) and the heating zone (220) are fluidly connected in a manner for the heating zone (220) to receive most of (preferably all of) the air exiting the forced draft device (295). The air outlet of the forced draft device (295) is preferably in direct fluid communication with the air inlet of the heating zone (220). In some embodiments, the air outlet of the forced draft device (295) and the air inlet of the heating zone (220) are proximate or contiguous. In preferred embodiments, the air outlet of the forced draft device (295) and the air inlet of the heating zone (220) are preferably closely-spaced aligned in a manner for the heating zone (220) to receive all of the air exiting the forced draft device (295).

The regasification apparatus (300) of FIG. 3 illustrates the positioning of the forced draft device (395) downstream of the heating zone (320) with respect to the air flow. The air inlet of the forced draft device (395) is in direct fluid communication with the air outlet (370) of the heating zone (320). In this case, the heating zone (320), the forced draft device (395) and the air vaporizer (310) are in serial air flow arrangement in the given order. The forced draft device (395) is preferably disposed between the air outlet (370) of the heating zone (320) and the top end (335) of the vaporizer (310). In some embodiments, the heating zone (320), the forced draft device (395), and the vaporizer (310) are stacked in serial vertical arrangement, with the heating zone (320) being on top of the stacking arrangement, and the vaporizer (310) being at the bottom of the stacking arrangement. In preferred embodiments, the forced draft device (395) is disposed at a lower elevation than the heating zone (320). The forced draft device (395) and the heating zone (320) are fluidly connected in a manner for the forced draft device (395) to receive most of (preferably all of) the air exiting the air outlet (370) of the heating zone (320). The air inlet of the forced draft device (395) and the air outlet (370) of the heating zone (320) are preferably closely-spaced aligned, and in some cases, are contiguous or proximate. In some embodiments, the air outlet of the forced draft device (395) and the air inlet (335) of the vaporizer (310) are preferably closely-spaced aligned, and in some cases, are contiguous or proximate.

Although not illustrated in FIG. 2 and 3, it is to be understood that the use of a plurality of forced draft devices is envisioned as an alternate embodiment of the present apparatus. The forced draft devices are preferably all positioned upstream (with respect to air flow) of the air vaporizer. The plurality of forced draft devices may be operated in parallel. For example, the plurality of the forced draft devices may be disposed above the air vaporizer at a similar elevation. Alternatively, the plurality of forced draft devices may be operated in series, that is to say, there are several forced draft devices disposed above the vaporizer but at different elevations so that there is an induced air draft for a draft device disposed at the higher elevation, and there is a forced air draft for a draft device disposed at the lower elevation. The plurality of air draft devices should still function to forcibly moving the air through the vaporizer. In preferred embodiments, the heating zone, the plurality of air draft devices and the vaporizer are air tight to avoid air leakage in between these units.

Although it is possible in FIG. 2 and 3, for the forced draft device (295; 395) to be positioned downstream of the vaporizer top end (235; 335), such as at an elevation in between the vaporizer top end (235; 335) and bottom end (240; 340), or even below the vaporizer bottom end (240; 340), such downstream arrangement of the draft device with respect to air flow is not preferred. A downstream-positioned draft device would not generate a forced air draft through the vaporizer (210; 310); but instead would provide an induced air draft through the vaporizer (210; 310). This induced air draft generated by a downstream-positioned draft device is not as efficient as compared to the forced draft generated by an upstream-positioned draft device, such as illustrated devices (295) and (395) in FIG. 2 & 3. Because a downstream-positioned draft device would be at a lower elevation that the vaporizer top end while the heating zone is at a higher elevation than the vaporizer top end, the downstream-positioned draft device cannot be contiguous to the air inlet of the vaporizer (210; 310) which is at or near its top end (235; 335). The non-contiguous position generally increases the risk of air leakage, as there would be no guarantee that all of the air exiting the heating zone (220; 320) would be forcibly moved in a generally downward manner through the vaporizer (210; 310). Additionally, there may be issues of water condensation on the mechanical parts of a downstream-positioned draft device located at or near the vaporizer bottom end (140; 240; 340). Thus, there is an increased risk of corrosion due to the more prominent water presence at and near the vaporizer bottom end (140; 240; 340) as indeed a fog tends to develop in this region during the vaporizer production mode. There are additional drawbacks for a downstream position of the draft device. A downstream-positioned draft device which is disposed directly underneath the vaporizer bottom end but not ducted to the vaporizer will be exposed to constant showering of water (due to ice melting) exiting the vaporizer bottom end. Such downstream-positioned draft device will also draw air from the sides of the vaporizer and hence will be less efficient. A downstream-positioned draft device which is disposed directly underneath the vaporizer bottom end and further connected to the vaporizer by ductwork will be exposed to constant fog and large water downpour. A draft device which is disposed aside from the vaporizer outside the vaporizer vertically-extended walls (e.g., not above the top end and not below the bottom end) will require additional air flow containment (such as ductwork) and will be less efficient due to its more distant position from the vaporizer and to the presence of elbow(s) in the ductwork. Thus for at least the above reasons, a downstream arrangement (with respect to air flow) of the draft device and the arrangement of the draft device on the side of the vaporizer are not recommended.

In alternate embodiments (not illustrated), the regasification apparatus may comprise an air heating zone, an air vaporizer and an eductor for drawing a hot air source and mixing the hot air source with ambient air and directing such air mixture to flow through the vaporizer. The eductor provides an acceleration of the air flow as it enters the vaporization.

Operation of Apparatus

Referring back to FIG. 1-3, the apparatus (100; 200; 300) may be operated under two different modes: a production mode and a regeneration mode.

The production mode may comprise the following steps: flowing air in a generally downward manner through the vaporizer (110; 210; 310) optionally with a forced air draft (such as in FIG. 2 and 3), wherein the flowing air externally contacts the flow passages (150; 250; 350) and is in heat transfer relation with the flow passages (150; 250; 350). The flowing air step may be carried out with a forced air draft (such as in FIG. 2 and 3), or with a natural air draft (such as in FIG. 1).

The production mode further includes passing the cryogenic fluid (175; 275; 375) through the flow passages (150; 250; 350) of the vaporizer (110; 210; 310). Cryogenic fluid (175: 275; 375) is fed to the vaporizer unit (110: 210; 330) via the cryogenic fluid inlet (155: 255; 355). The flow of the cryogenic fluid (175; 275; 375) can be regulated, stopped and/or resumed by valve (178; 278; 378). Heat transfer occurs between the flowing air contacting the external surfaces (including fins) of the flow passages (150; 250; 350) and the cryogenic fluid flowing inside the flow passages (150; 250; 350). As a result of this heat exchange, the air passing through the vaporizer (110; 210; 310) gets cooler, while the cryogenic fluid (175; 275; 375) gets warmer and vaporizes into gas to generate a produced gas (180; 280; 380). The produced gas (180; 280; 380) exits the flow passages (150; 250; 350) through the vaporizer gas outlet (160; 260; 360) at a desired flow rate and with an exit gas temperature T_{g}. The gas flow rate may be regulated, stopped and/or resumed by the gas valve (188; 288; 388). The cooling air can travel in a generally downward manner through a natural draft apparatus due to difference in air density (such as is described for FIG. 1); or can travel in a generally downward manner through a forced draft apparatus due to a generated downward forced draft (such as is described for FIG. 2 and 3). The cooling air finally exits the vaporizer (210; 310) via the vaporizer air outlet disposed at or near the vaporizer bottom end (140; 240; 340).

The air flowing with a forced draft through the vaporizer (210; 310) may have a linear air velocity from 0.1 ft/sec to 1000 ft/sec.

The step for passing the cryogenic fluid is performed in production mode at a pressure of up to 2,600 psia, preferably between 500 psia and 2,600 psia (between 3.4 MPa and 18 MPa).

During the production mode where the air and the cryogenic fluid flow externally and internally, respectively, through the vaporizer (110; 210; 310), the air cooling close to the external surfaces (including fins) of the flow passages (150; 250; 350) results in a temperature drop and may cause the condensation of moisture (i.e., water vapor) from the air. As moisture collects on the external surfaces of the flow passages (150; 250; 350), this moisture may form a snow-like frost which can deposit on the external surfaces of flow passages. Frost deposit is typically heaviest when the ambient air temperature is between 32° F. and 41° F. (between 0° C. and 5° C.), and when there is high humidity in the ambient air. The rate of frost deposit decreases when ambient air temperature falls below 32° F. (0° C.), as colder air typically holds less moisture.

The production mode may further comprise heating ambient air having a first temperature to form heated air having a second temperature, the heating step being carried out before the heated air enters and flows through the vaporizer (110; 210; 310). The air heating step is preferably performed during production mode when a certain vaporizer performance criterion is no longer met, such as for example when the exit gas temperature T_{g} is below a predetermined value, or when the produced gas flow rate does not meet a minimum delivery flow rate for a gas pipeline.

A regeneration step is preferably performed to allow defrosting of the flow passages (150; 250; 350), especially when a certain vaporizer performance criterion is no longer met, such as for example when the exit gas temperature T_{g} is below a predetermined value.

The regeneration mode may comprise the following steps: not passing the cryogenic fluid (175; 275; 375) or discontinuing the passing of the cryogenic fluid (175; 275; 375) through the flow passages (150; 250; 350); and carrying out the air flowing step, preferably although not necessarily with a forced air draft.

The regeneration mode further comprises heating ambient air having a first temperature T₁ to form heated air having a second temperature T₂ before air enters and flows through the vaporizer (110; 210; 310). The air heating step is preferably performed when a certain ambient air condition is no longer met, such as for example when the ambient air temperature T₁ is below a pre-selected value T₁^{s}.

In order to switch the operation of the vaporizer (110; 210; 310) from production mode to regeneration mode, the step for passing the cryogenic fluid (175: 275; 375) through the vaporizer flow passages (150; 250; 350) is terminated. This step termination can be effected by preferably closing the gas valve (188; 288; 388) of the produced gas (180; 280; 380); alternatively by closing the cryogenic fluid valve (178: 278; 378); or by closing both valves in a staggered fashion

In order to switch the operation of the vaporizer (110; 210; 310) from regeneration mode to production mode, the step for passing the cryogenic fluid (175: 275; 375) through the vaporizer flow passages (150; 250; 350) is initiated or resumed. This initiation or restart step can be effected by preferably opening the gas valve (188; 288; 388); alternatively, by opening the cryogenic fluid valve (178: 278; 378); or by opening both valves in a staggered fashion.

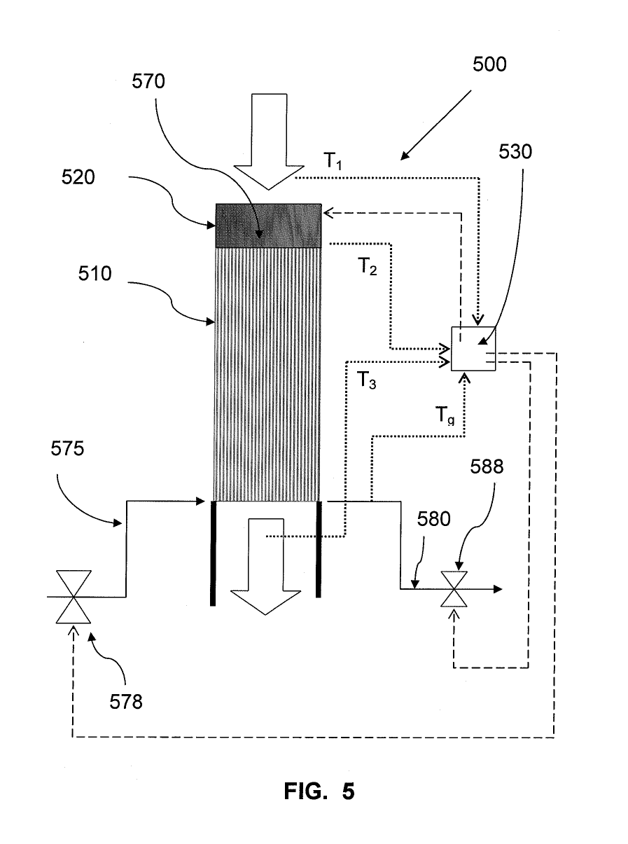

In some embodiments for the cyclic operation between production mode and regeneration mode, the opening or closing of the cryogenic fluid valve (178: 278; 378) and/or the gas valve (188; 288; 388) may be actuated by the regulator device (130; 230; 330). For example, if the exit gas temperature T_{g} is less than a predetermined exit gas temperature T_{g}^{s}, the gas valve (188; 288; 388) may be closed to stop the flow of the produced gas (180; 280; 380); or the valve (178: 278; 378) may be closed off to stop the flow of the cryogenic fluid (175; 275; 375); or both valves may be closed in a staggered fashion. Other possible actuations of the gas valve (188; 288; 388) and/or the cryogenic fluid valve (178: 278; 378) may be provided by a feedback control on the air temperature (such as T₁, T₂ and/or T₃) measured at one or various locations in and around the regasification apparatus (100; 200; 300) or a difference in air temperature (such as T₂−T₃ or T₁−T₃). FIG. 5 which is described later illustrates an example of a regasification apparatus 500 which uses a regulator device 530 to actuate the operation of either or both of a gas valve 588 and a cryogenic fluid valve 578. Air temperature T₁, T₂, T₃ or combinations thereof can be used to determine the cycle time between production mode and regeneration mode.

The operation of the regasification apparatus (100) in FIG. 1 with respect to air flow is described as follows. Ambient air (185) at a temperature T₁ passes though the heating zone (120) and exits the heating zone (120) via the heating zone air outlet (170). The air exiting the heating zone (120) at a temperature T₂ then flows through the vaporizer air inlet generally disposed at the top end (135) of the vaporizer (120). The air then passes through the vaporizer (110) and contacts the external surfaces of the flow passages (150) where the air gets cooled. The cooled air at a temperature T₃ then exits the vaporizer (110) via its air outlet located at or near the vaporizer bottom end (140).

The operation of the regasification system (200) in FIG. 2 with respect to air flow is described as follows. Ambient air (285) at a temperature T₁ is forcibly moved by the forced draft device (295) and exits the forced draft device (295) to be directed towards the heating zone (220). The forcibly moved air flows through the heating zone (220) to finally exit the heating zone (220) via the heating zone outlet (270). The forcibly moved air exiting the heating zone air outlet (270) at a temperature T₂ then flows into the vaporizer via its air inlet at or near its top end (235). The forcibly moved air passes through the vaporizer (210) and contacts the external surfaces of the flow passages (250) where the air gets cooled. The forcibly moved cooled air at a temperature T₃ then exits the vaporizer (210) via the vaporizer air outlet located at or near the vaporizer bottom end (240). Since the forced draft device (295) typically forces ambient air in a generally downward manner (i.e., the air inlet of the forced draft device (295) is disposed at a higher elevation than its air outlet), the air flow through the heating zone (220) and through the vaporizer (210) is also in a generally downward manner.

The operation of the apparatus (300) in FIG. 3 with respect to air flow is described as follows. Ambient air (385) at a temperature T₁ enters the heating zone (320). The air flowing through the heating zone (320) is forcibly moved through the heating zone (320) via an induced draft by the suction provided by the forced draft device (395). Since the air draft device (395) typically forces ambient air in a generally downward manner (i.e., the air inlet of the forced draft device (395) is disposed at a higher elevation than its air outlet.), the air flow through the heating zone (320) is also in a generally downward manner. The forcibly moved air at a temperature T₂ exits the heating zone (320) via the heating zone air outlet (370). The air then passes through the air draft device (395) to exit via its air outlet (with an increased volumetric flow rate compared to that at the air inlet of the forced draft device (395)) and is then directed towards the air inlet of the vaporizer (310). The forcibly moved air passes through the vaporizer (310) and contacts the external surfaces of the flow passages (350) where the air is cooled to finally exit the vaporizer (310) at a temperature T₃ via the vaporizer air outlet located at or near the vaporizer bottom end (340).

When the heating zone (120; 220; 320) is in operation, as the ambient air enters the heating zone (120; 220; 320) at a first temperature T₁ and flows, either without forced draft (as in FIG.1) or with forced draft (as in FIG. 2 and 3) though the heating zone (120; 220; 320), ambient air gets heated and exits the heating zone (120) at a second temperature T₂ which is greater than the air first temperature T₁.

When the heating zone (120; 220; 320) is not in operation, the temperature of the ambient air passing though the heating zone (120; 220; 320) is generally not changed, and the air exiting the heating zone (120; 220; 320) has a second temperature T₂ which is equal to the ambient air first temperature T₁.

Although the heating zone (120; 220; 320) may be continuously operated during the regeneration mode and/or during the production mode, it is preferred to only intermittently operate the heating zone (120; 220; 320) during the regeneration mode to incur minimal operational costs of the apparatus (100: 200: 300). For example, defrosting is effective when the air temperature is at or above the ice melting point, but not very effective when the air temperature is below the ice melting point. Thus in instances where the ambient air is below the pre-selected temperature T₁^{s} such as below the ice melting point or 40° F. or less, defrosting is preferably carried out by heating the ambient air to a temperature at or above the pre-selected temperature T₁^{s} before air enters the vaporizer (110; 210; 310).

In instances when the ambient air temperature T₁ is higher than the pre-selected temperature T₁^{s} (such as at or above 40° F.), the heating zone (120; 220; 320) may not be operated at all.

During production mode, vaporization is still effective even when the air temperature is below the pre-selected temperature T₁^{s} (such as below the ice melting point), because there exists a large temperature difference between the cryogenic fluid (175; 275; 3875) and the ambient air (180; 280; 380) flowing through the vaporizer (110; 210; 310). Thus, the vaporization generally does not require ambient air heating. In some instances however, the vaporization may be supplemented with ambient air heating to improve the vaporizer capacity and/or its efficiency. Intermittent heating of ambient air during production mode may be done to increase the air temperature, although not necessarily to a value equating or exceeding the pre-selected temperature T₁^{s} (such as the ice melting point) before air enters the vaporizer (110; 210; 310).

As a result of the intermittent heating of the ambient air, the temperature T₂ of the air entering the vaporizer air inlet may be equal to or greater than the ambient air first temperature T₁. That is to say, when the heating zone (120; 220; 320) is not in operation, the (forcibly or not) moved air entering the vaporizer air inlet comprises a second temperature T₂ which is equal to the ambient air first temperature T₁. Alternatively when the heating zone (120; 220; 320) is in operation, the (forcibly or not) moved air entering the vaporizer air inlet comprises a second temperature T₂ which is greater than the ambient air first temperature T₁.

As for the use of forced draft in the vaporizer (210; 310), because heated ambient air tends to be less dense than ambient air, it is preferred to operate the vaporizer (210; 310) with a forced air draft to forcibly move the heated air in a downward manner. Although the operation of the vaporizer (210; 310) with forced air draft during regeneration mode and without forced air draft during production mode is within the intended use of the apparatus (200; 300), it is however preferred to continuously operate the vaporizer (210; 310) with forced air draft during both production and regeneration modes, i.e., the forced air device (295; 395) is preferably continuously in operation.

Referring again to the production mode of operation of the vaporizer (110; 210; 310) in FIG. 1, 2 and 3, even though the frost or ice deposited on the external surfaces (including fins) of the flow passages (150; 250; 350) does reduce the efficiency of the vaporizer (110; 210; 310), the vaporizer (110; 210; 310) can still function properly, so long as some fins remain frost-free or without ice bridging. Indeed, iced fins can still function but at a reduced efficiency compared to frost-free fins.

Vaporizer efficiency loss may be indicated when the exit gas temperature T_{g} is less than a desired value, such as a predetermined exit gas temperature (T_{g}^{s}), suitable for either downstream processing or for pipeline delivery.

During production mode, vaporizer efficiency loss may be indicated when the difference in air temperature ΔT (in absolute value) between the second temperature T₂ of the air entering the vaporizer and the third temperature T₃ of the air exiting the vaporizer (i.e, |T₂−T₃|) is less than a desired minimum temperature gap (ΔT^{s}). Desired minimum temperature gap may be equal to or more than 10° F. (5.5° C.), or preferably equal to or more than 20° F. (11° C.). In some embodiments, the gap |T₂−T₃| may be between 10° F. and 70° F. (gap between 5.5° C. and 39° C). In other embodiments, the gap |T₂−T₃| may be between 20° F. and 50° F. (gap between 5.5° C. and 28° C.). Indeed, as the vaporizer gets more and more frost deposit, there is less efficiency in heat exchange between the air and the cryogenic fluid (due in part to air flow hindrance and less heat transfer surface area), thus the cooling of the air is less and less. As a result, the difference in temperature |T₂−T₃| between the air entering the vaporizer and the air exiting the vaporizer decreases during production mode from a ‘peak’ ΔT to a ‘threshold’ minimum ΔT.

Additional or alternative indicators for vaporizer efficiency loss during production mode may include frost thickness, extent of surface coverage by frost on the flow passages (150; 250; 350) and/or bridging of ice between fins.

During regeneration mode, vaporizer efficiency recovery may be indicated when the difference in air temperature ΔT (in absolute value) between the second temperature T₂ of the air entering the vaporizer and the third temperature T₃ of the air exiting the vaporizer (i.e., |T₂−T₃|) approaches zero. Indeed, as more and more frost deposit gets removed by melting, the air passing externally over the melting external surfaces cools less and less. As a result, for a vaporizer under regeneration, the difference in air temperature |T₂−T₃| between the air entering the vaporizer and the air exiting the vaporizer decreases until |T₂−T₃| approaches zero, at which point the vaporizer is fully regenerated and can then be switched to production mode.

Additional or alternative indicators for vaporizer efficiency recovery during regeneration mode may include no frost deposit and/or no bridging of ice between fins.

The primary function of the regulator device (130; 230; 330) is to facilitate the intermittent operation of the heating zone (120; 220; 320) by directing its ‘activation’ or its ‘termination’, preferably during a regeneration mode (i.e., defrosting period) and optionally during a production period. The intermittent operation can be done with the monitoring of at least one of the following process variables: the air temperatures T₁, T₂, T₃; the exit gas temperature T_{g}; the frost or ice thickness; the extent of coverage by frost on external surfaces of the flow passages (150; 250; 350); and/or bridging of ice between fins.

In some embodiments, under production mode of the regasification apparatus (100; 200; 300), the regulator device (130; 230; 330) does not actuate the operation of the heating zone (120; 220; 320). The regulator device (130; 230; 330) may receive an output value for the flow rate of the produced gas (180; 280; 380), and when the output value is not 0 (i.e., gas is being produced), the regulator device (130; 230; 330) does not actuate or terminates the operation of the heating zone (120; 220; 320).

In some embodiments, under production mode of the regasification apparatus (100; 200; 300), when the first temperature T₁ is above a pre-selected first temperature (T₁^{s}), the regulator device (130; 230; 330) does not actuate or terminates the operation of the heating zone (120; 220; 320). Alternatively, when the difference in temperature ΔT (in absolute value) between the measured air second temperature T₂ and the measured air third temperature T₃ is more than a desired minimum ΔT^{s}, the regulator device (130; 230; 330) does not actuate or terminates the operation of the heating zone (120; 220; 320).

During a production mode, when the air first temperature T₁ is equal to or below the pre-selected first temperature (T₁^{s}), and/or when the difference in temperature ΔT (in absolute value) between the air second temperature T₂ and the air third temperature T₃ is less than a desired minimum ΔT^{s}, the regulator device (130; 230; 330) may initiate or resume the operation of the heating zone (120; 220; 320). The ‘activation’ of the heating zone (120; 220; 320) during the production mode thus may provide an increase in the exit gas temperature T_{g} until T_{g} equates or exceeds the predetermined exit gas temperature T_{g}^{s}. The ‘activation’ of the heating zone (120; 220; 320) may provide an increase in ΔT (in absolute value) between T₂ and T₃, until ΔT equates or exceeds the minimum value ATS.

During regeneration periods when there is no passing of the cryogenic fluid (175: 275; 375) through the vaporizer (110; 210; 310) and thus no production of gas (180: 280; 380), the vaporizer (110; 210; 310) may be undergoing defrosting where accumulated frost and/or ice is allowed to melt, and the resulting water drips from piping and surfaces underneath the bottom end (140; 240; 340) of the vaporizer (110; 210; 310).

In some embodiments, under regeneration mode of the vaporizer (110; 210; 310), when the first temperature T₁ is above a pre-selected first temperature (T₁^{s}), the regulator device (130; 230; 330) does not actuate or terminates the operation of the heating zone (120; 220; 320). Alternatively under regeneration mode, when the first temperature T₁ is equal to or below a pre-selected first temperature (T₁^{s}), the regulator device (130; 230; 330) initiates or resumes the operation of the heating zone (120; 220; 320).

FIG. 4-6 illustrate alternate embodiments of regasification apparatus (400; 500; 600) for vaporizing cryogenic fluid to gas according to the present invention.

With respect to intermittent operation of a plurality of heating zones associated with a plurality of vaporizers, an alternate embodiment of a regasification apparatus is illustrated in FIG. 4.

Regasification apparatus (400) comprises two or more vaporizers (two vaporizers 410a and 410b shown in FIG. 4) operated in parallel, and a single regulator device (430). In such case, the regulator device (430) facilitates, in an independent manner, the intermittent operation of the heating zones (420a; 420b) which are respectively disposed above the two vaporizers (410a; 410b). In this regasification apparatus (400), the regulator device (430) generally comprises a computer, which receives output values from analyzers for different variables (such as for example T₁, T₂, T₃, T_{g}, |T₂−T₁|, ΔT=|T₂−T₃| for each vaporizer) and then compares these values with pre-selected setpoints (such as T₁^{s}, T₂^{s}, T₃^{s}, T_{g}^{s}, ΔT^{s}). In this manner, the regulator device (430) may terminate or resume via feedback control the operation of either or both of the heating zones (420a; 420b) in an independent manner. It is envisioned to pre-select the same setpoint or different setpoints for a process variable (such as T₁^{s}, T₂^{s}, T₃^{s}, T_{g}^{s}, ΔT^{s}) for the plurality of the regasification units.

With respect to the use of a common regulator device for the cyclic operation of an air vaporizer and the intermittent operation of an air heating zone upstream of the air vaporizer, an alternate embodiment of a regasification apparatus is illustrated in FIG. 5.

Regasification apparatus (500) comprises an air vaporizer (510), a heating zone (520), and a regulator device (530), in which the regulator device (530) not only is effective in intermittently operating the heating zone (520), but the regulator device (530) can also facilitate the cyclic operation of the air vaporizer (510) between production mode and regeneration mode. For example, the regulator device (530) may direct the closing or opening of the gas valve (588) or the closing or opening of the cryogenic fluid valve (578) or both in a staggered fashion in order to switch the air vaporizer (510) from production mode to regeneration mode, or vice versa. The closing or opening of valve (578) or valve (588) can be done by feedback control of at least one of the following process variables, for example: T₁, T₂, T₃, T_{g}, ΔT=|T₂−T₃|, the frost thickness and/or the fraction of the vaporizer external surfaces which is covered by accumulated frost. The feedback control may be manual or automatic. In preferred embodiments, the regulator device (530) comprises a computer which receives a plurality of output values for key process variables (such as those described above) from analyzers or monitoring devices or from visual inspections, compares these output values from setpoint values (such as T₁^{s}, T₂^{s}, T₃^{s}, T_{g}^{s}, ΔT^{s}, frost thickness threshold) which are pre-selected for these key process variables and actuates the cyclic operation of the air vaporizer (510) and the intermittent operation of the heating zone (520).

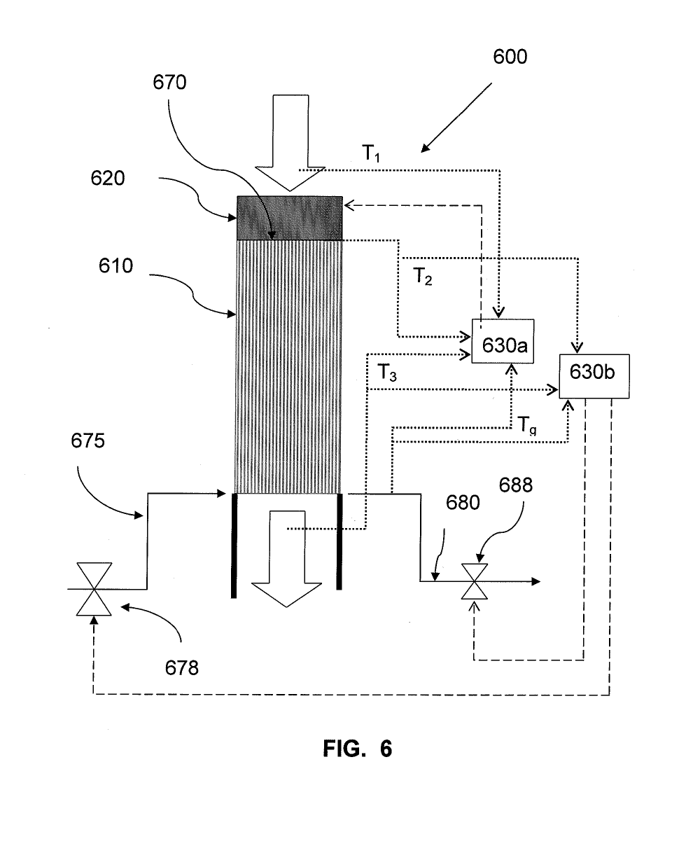

With respect to the use of separate regulator devices for the cyclic operation of a vaporizer and the intermittent operation of a heating zone, an alternate embodiment of a regasification apparatus is illustrated in FIG. 6.

Regasification apparatus (600) in FIG. 6 comprises an air vaporizer (610), a heating zone for heating ambient air (620), and two regulator devices (630a and 630b), in which the intermittent operation of the heating zone (620) and the cyclic operation of the air vaporizer (610) are independently provided by these two respective regulator devices (630a) and (630b). For example, the intermittent operation of the heating zone (620) can be done via the regulator device (630a) by feedback control of at least one of the following process variables, such as T₁, T₂, T₃, T_{g}, |T₂−T₁| and/or ΔT=|T₂−T₃|, the frost thickness and/or the portion of the vaporizer external surfaces which is covered by accumulated frost. The regulator device (630b) facilitates the cyclic operation of the vaporizer (610) for example by directing the closing or opening of gas valve (688) and/or cryogenic fluid valve (678) in order to switch the vaporizer (610) from production mode to regeneration mode or vice versa. For example, the closing or opening of gas valve (688) and/or cryogenic fluid valve (678) can be done by feedback control of at least one of the following process variables: the exit gas temperature T_{g} of the produced natural gas (680); the gap between the temperature (either T₁ or T₂) of the air entering the vaporizer (610) and the temperature T₃ of the air exiting the vaporizer (610), the frost or ice thickness and/or the fraction of the vaporizer external surfaces which is covered by accumulated frost.

The following ranges on certain variables apply to all embodiments of the present invention.

The air second temperature (T₂) may be the same as the air first temperature (T₁) when the heating zone (120; 220; 320) is not in operation, such as immediately prior to production mode.

The air second temperature (T₂) may be greater than the air first temperature (T₁) when the heating zone (120; 220; 320) is in operation, such as during regeneration mode, especially when the air first temperature (T₁) is below a pre-selected air first temperature (T₁^{s}).

The air first temperature (T₁) of the ambient air may be any temperature in the continuum between −10° F. and 122° F. (between −23° C. and 50° C.).

The pre-selected air first temperature (T₁^{s}) may be any temperature between 32° F. and 50° F. (between 0° C. and 10° C.), preferably any temperature between 32° F. and 41° F. (between 0° C. and 5° C.).

The air second temperature (T₂) may be any temperature in the continuum between −40° F. and 122° F. (between −40° C. and 50° C.) when the heating zone is not operational. The air second temperature (T₂) may be any temperature in the continuum between 32° F. and 70° F. (between 0° C. and 20° C.) when the heating zone is operational during regeneration mode. The air second temperature (T₂) may be any temperature in the continuum between −4° F. and 122° F. (between −20° C. and 50° C.) when the heating zone is operated during production mode.

The pre-selected air second temperature (T₂^{s}) may be any temperature between 32° F. and 70° F. (between 0° C. and 20° C.); alternatively, any temperature between 32° F. and 50° F. (between 0° C. and 10° C.); or alternatively, any temperature between 32° F. and 41° F. (between 0° C. and 5° C.).

The cryogenic fluid entering the air vaporizer may have a temperature equal to or less than −170° F. (−112° C.), preferably between −260° F. and −220° F. (between −160° C. and −140° C.). The cryogenic fluid may have a pressure up to 2,600 psia, preferably between 500 psia and 2,600 psia (between 3,445 kPa and 17,925 kPa). The cryogenic fluid is preferably liquefied natural gas.

The produced gas exiting the air vaporizer may have an exit temperature T_{g} between −100° F. and 90° F. (between −73° C. and 32.2° C.), preferably between −40° F. and 60° F. (between −40° C. and 15.5° C.). The produced gas may comprise a pressure up to 2,600 psia, preferably between 500 psia and 2,600 psia (between 3,445 kPa and 17,925 kPa). The produced gas preferably comprises at least 90 percent by volume of methane. More preferably, the produced gas consists of natural gas. The produced gas is most preferably natural gas which has undergone one or more pretreatments prior to the liquefaction process for removal of carbon dioxide and some metals present in the extracted natural gas.

The predetermined exit gas temperature (T_{g}^{s}) may range from −40° F. to 86° F. (between −40° C. and 30° C.), preferably from −30° F. to 70° F. (between −34° C. and 21° C.), more preferably from −25° F. to 50° F. (between −32° C. and 10° C.), still more preferably from −25° F. to 40° F. (between −32° C. and 4.4° C.). In alternate embodiments, the predetermined gas temperature (T_{g}^{s}) may range from −36° F. to 41° F. (between −38° C. and 5° C.).

The desired minimum ΔT^{s} (in absolute value) between T₂ and T₃ (when the heating zone is operational) or between T₁ and T₃ (when the heating zone is not operational) may be at least 10° F. (5.5° C.), preferably at least 15° F. (8° C.), more preferably at least 20° F. (11° C.).

In other embodiments, the gap ΔT between T₂ and T₃ may be between 10° F. and 70° F. (between 5.5° C. and 39° C.). In yet other embodiments, the gap ΔT between T₂ and T₃ may be between 20° F. and 50° F. (between 1° C. and 28° C.).

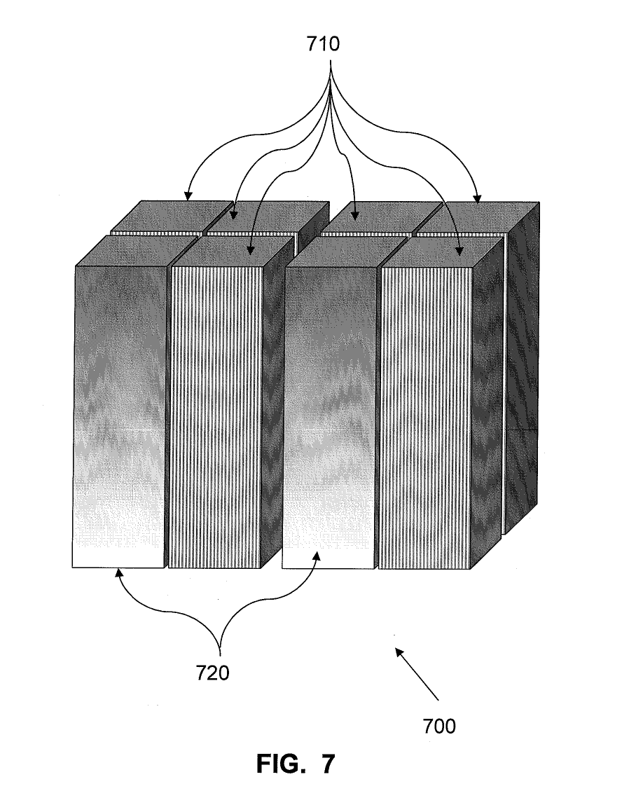

With respect to the cyclic operation of a plurality of vaporizers, a regasification plant is illustrated in FIG. 7. Regasification plant (700) for vaporization of cryogenic fluid to gas comprises a plurality of regasification units (including air vaporizers). Two banks of air vaporizer units are illustrated in FIG. 7, but it should be understood that the description of the cyclic operation of the regasification units in the regasification plant (700) is applicable to any number of regasification units of two or more. Any of the regasification units illustrated as apparatus (100), (200), (300), (400), (500), and (600) in FIG. 1 through 6 respectively, and described previously can be used in the plurality of the regasification units in the regasification plant (700), so long as each regasification unit comprises an air vaporizer comprising flow passages for passing the cryogenic fluid in indirect heat transfer with air and an ambient air heating zone located upstream (with respect to air flow) of the air vaporizer. Preferably although not necessarily, each regasification unit may further comprise a forced air draft device as described previously.

The method for converting a cryogenic fluid to gas in the regasification plant (700) comprises 1) operating a first subset (710) of the plurality of the regasification units being in production mode, wherein the production mode for an air vaporizer in each regasification unit in the first subset comprises the following steps: (a) moving air in a downward manner through the vaporizer, the moved air externally contacting the flow passages and being in heat transfer relation with the flow passages; (b) passing the cryogenic fluid through the flow passages of the vaporizer to vaporize the cryogenic fluid and to generate a gas; and 2) operating a second subset (720) of the plurality of the regasification units in a regenerative mode, wherein the regenerative mode for an air vaporizer in each regasification unit in the second subset comprises (c) not passing the cryogenic fluid through the flow passages of the vaporizer; (d) moving air in a downward manner with a forced air draft through the vaporizer, wherein the moved air externally contacts the flow passages and is in heat transfer relation with the flow passages; and (e) heating ambient air having a first temperature to form heated air having a second temperature, wherein the step (e) is carrying out before the heated air is forcibly moved through the vaporizer.

The step (b) for passing cryogenic fluid under production mode is performed at a pressure up to 2,600 psia (up to 18 MPa), preferably between 500 psia and 2,600 psia (between 3.4 MPa and 18 MPa).

In preferred embodiments of the regasification plant (700), the cryogenic fluid is liquefied natural gas. The produced gas is natural gas.

Step (e) is preferably carried out in an intermittent fashion.

The step (e) for intermittent air heating may comprise (e1) heating the ambient air when the air first temperature (T₁) is equal to or less than a pre-selected first temperature (T₁^{s}) to achieve a second temperature (T₂) greater than the first temperature. Step (e1) may for example comprise heating the ambient air, when the first temperature (T₁) is equal to or less than T₁^{s} which may range from 32° F. to 50° F. (from 0° C. to 10° C.).

The step (e) for intermittent air heating may comprise (e2) discontinuing heating of the ambient air when the air first temperature (T₁) is greater than the above-mentioned pre-selected first temperature (T₁^{s}) used in step (e1) or another pre-selected first temperature (T₁^{s}). The other pre-selected first temperature (T₁^{s}) may be any temperature between 34° F. and 50° F. (between 1° C. and 10° C.).

The step (b) for passing cryogenic fluid in the production mode generates a cooled air exiting the vaporizer, wherein the cooled air has a third temperature (T₃) which differs from the second temperature (T₂) of the air entering the vaporizer by at least a minimum temperature gap, wherein the minimum temperature gap may be 10° F. or higher (gap of 5.5° C. or higher), or 20° F. or higher (gap of 11.1° C. or higher).

When one vaporizer in production mode generates a gas in step (b) having an exit gas temperature (T_{g}) lower than a predetermined exit gas temperature (T_{g}^{s}), the vaporizer is switched to regeneration mode by performing steps (c) through (e).

The production mode of one vaporizer from the first subset (710) may be terminated when step (b) generates a produced gas having a gas outlet temperature (T_{g}) lower than a predetermined gas temperature (T_{g}^{s}). The production mode termination may be carrying out by discontinuing step (b) in order to initiate step (c).

Alternatively or additionally, the production mode of one vaporizer from the first subset (710) may be terminated when the difference (ΔT in absolute value) between the third temperature (T₃) of the air exiting the vaporizer and the second temperature (T₂) of the air entering the vaporizer is less than a desired minimum temperature gap (ΔT^{s}). The desired minimum temperature gap (ΔT^{s}) may be at least 10° F. (5.5° C.), preferably at least 20° F. (11° C.). The temperature gap (ΔT) may range from 10° F. to 70° F. (from 5.5° C. to 39° C.). The production mode termination may be carrying out by discontinuing step (b) in order to initiate step (c).

Alternatively or additionally, the production mode of one vaporizer from the first subset (710) may be terminated when the frost thickness is greater than a threshold value and/or when the frost covers a threshold fraction of the external surfaces of the flow passages, for example when more than 75% of the external surfaces of the flow passages, preferably more than 85% of the external surfaces, are covered with frost. The production mode termination may be carrying out by discontinuing step (b) in order to initiate step (c).

In the event that the production mode of a vaporizer from the first subset (710) is terminated, a regeneration mode may be initiated for this vaporizer by carrying out the forcibly moving air step (d) and the intermittent air heating step (e), thus effecting a switch from production mode to regeneration mode and for this vaporizer to be part of the second subset (720).

In some instances, for a vaporizer of the first subset (710) in production mode, step (a) may be carried out with a forced air draft, that is to say, may comprise moving the air in a downward manner with a forced draft through the vaporizer. The intermittent air heating step (e) may be also carried out in production mode.

The step (e) for intermittent air heating and the air flowing step (a) carried out with a forced air draft may be performed during production mode, either separately or concurrently.

Additionally, for a vaporizer of the second subset (720) in regeneration mode, the regeneration mode of this vaporizer may be terminated by resuming step (b) for passing the cryogenic fluid, thus effecting a switch from regeneration mode to production mode and for this vaporizer to now be part of the first subset (710). The switch from regeneration mode to production mode may comprise terminating the air heating step (e). The switch from regeneration mode to production mode may further comprise removing the forced air draft in the air flowing step (a).

The timing of the cyclic operation between production mode and regeneration mode may depend in part upon the humidity level and/or temperature of the ambient air.

The run time for the regeneration mode is preferably carried out for about a fourth to half of the run time for the production mode.

The production mode is typically carried out for a run time between 1 and 24 hours, preferably for a run time period between 1.5 and 16 hours, more preferably for a time period between 2 and 8 hours.

The regeneration mode is typically carried out for a run time between 0.25 and 12 hours, preferably for a run time period between 0.5 and 6 hours, more preferably for a time period between 0.5 and 4 hours.

The vaporizers from the first subset (710) under production mode provide a plurality of produced gas stream, which are generally pooled to provide a produced gas pooled stream. For the entire plant (700). This produced gas pooled stream preferably may have an average exit gas temperature (T_{g}^{av}) between −40° F. and 60° F. (between −40° C. and 15.5° C.), preferably between 30° F. and 50° F. (between −34° C. and 10° C.), more preferably between −25° F. and 40° F. (between 32° C. and 4.5° C.).

As a non-limiting example, a LNG regasification plant similar to plant (700) may comprise eight parallel banks of regasification units, each bank comprising ten air vaporizers, for a total of eighty air vaporizers in the LNG regasification plant. The cyclic operation of such plant may require five out of the eight banks to be in production mode, while the other three banks are in regeneration, either at different stages of defrosting or at a similar stage of defrosting. About 1 to 1.5 billions of cubic feet per day of natural gas may be generated in this manner. For a given amount of air vaporizers, the average exit gas temperature T_{g}^{av} tends to increase with a shorter production mode run time. For example, with ambient air having a temperature T₁ of 60° F. and a humidity level of 60% and the use of a 80-vaporizer plant, the average exit gas temperature T_{g}^{av} is expected to be from 20° F. and −40° F. (from −6° C. to −40° C.) by varying the production mode run time of between 1.5 hour and 6.5 hours (the lowest production mode run time resulting in the highest average exit gas temperature).

The variation in exit gas temperatures in the various generated gas streams from the producing vaporizers will depend on the numbers of banks of vaporizers operating in the regasification plant. The greater the number of banks of vaporizers in the plant, the less the temperature swing in exit gas temperature of the various generated gas streams will be. This tighter control in exit gas temperature of the plurality of produced gas streams is related to carrying out the regeneration mode at staggered intervals between the banks, to provide varying degrees of defrosting. This staggering of defrosting can be done more efficiently with a larger number of banks. For example only, with a 80-vaporizer plant with 50 vaporizers in production mode, 8 banks of 10 vaporizers may generate a 24° F. (13° C.) variation in exit gas temperatures of the various produced gas streams from the 50 producing vaporizers, while 40 banks of 2 vaporizers with 50 vaporizers in production mode may generate a 5° F. (2.8° C.) variation in exit gas temperatures of the various produced gas streams from the producing 50 vaporizers.

In some LNG regasification facilities using the apparatus of the present invention, ‘trim’ heater(s) can be used to increase the exit temperature of the produced gas which exits the air vaporizer in order for the produced gas to have a desired send-out gas temperature for a natural gas pipeline, e.g., from 20° F. to 100° F. (from −6.7° C. to 37.8° C.) or from 40° F. to 90° F. (from −6.7° C. to 32.2° C.). It may be desirable for the exit gas temperature T_{g} of the produced gas to be maintained at the gas outlet of the vaporizer at a predetermined gas temperature so that the energy requirement for bringing the produced gas from T_{g} to the desired send-out gas temperature is relatively constant.

The present invention may displace the common use of ‘trim’ heater(s) during the downstream processing (after vaporization) before the natural gas pipeline delivery, depending upon the pipeline specifications for send-out gas temperature, and within the confines of the more preferred embodiments of the present invention. This displacement of energy use during the regeneration mode (and optionally during the production mode) of the air vaporizer allows for a more flexible utilization of ambient air vaporizers for continuous base-load LNG regasification facilities at locations which would not have been previously selected based on unfavorable weather conditions.

It is expected that the energy requirement for operation of such regasification apparatus is much less than that of a SCV unit. It is estimated that, when the intermittent air heating is used during regeneration mode, the operation of the improved air vaporizer apparatus would spend ca. 0.2 to 0.3% of the generated natural gas, which is a much reduced operating cost than what is currently needed for the operation of a SCV apparatus.

Where a plurality of regasification units is used in a base-load LNG regasification plant, the plurality of regasification units preferably consists essentially of a plurality of the improved air regasification apparatus according to the present invention. In this case, the base-load LNG regasification plant preferably excludes other types of vaporization units, such as excludes submerged combustion vaporizers and/or open-rack vaporizers.

In some embodiments, the method for regasifying LNG can exclude other methods of vaporization in which the heat is required to vaporize the LNG is extracted from a water source.

While preferred embodiments of the invention have been shown and described, modifications thereof can be made by one skilled in the art without departing from the spirit of the invention.

What is claimed is:

1. A method of converting cryogenic fluid to gas in a vaporizer comprising flow passages for cryogenic fluid flow, said method comprising:
(a) moving air in a downward manner through the vaporizer, said moved air externally contacting said flow passages and being in heat transfer relation with said flow passages;
(b) passing said cryogenic fluid through the flow passages of the vaporizer to vaporize said cryogenic fluid and to generate a gas;
(c) discontinuing step (b);
(d) carrying out step (a) with a forced air draft; and
(e) heating ambient air having a first temperature to form intermittently heated air having a second temperature, said step (e) being carrying out before said heated air moves through the vaporizer.

2. The method according to claim 1, further comprising
carrying out the air heating step (e) while carrying out steps (a) and (b) to generate the gas.

3. The method according to claim 2, wherein the heating step (e) is carried out when the exit gas temperature is less than a predetermined exit gas temperature.

4. The method according to claim 3, wherein the predetermined exit gas temperature of the generated gas exiting the vaporizer is between −51° C. and 38° C.

5. The method according to claim 1, wherein a frost is deposited externally on said flow passages during step (b), and further wherein the steps (c), (d) and (e) are performed to allow defrosting of said flow passages.

6. The method according to claim 1, wherein step (a) is carried out with a forced air draft.

7. The method according to claim 1, wherein step (b) is performed at a pressure between 3.4 MPa and 18 MPa for the cryogenic fluid.

8. The method according to claim 1, wherein the heating step (e) comprises
(e1) heating of said ambient air when the air first temperature is less than a pre-selected first temperature ranging from 0° C. to 10° C., to achieve a second temperature greater than said first temperature; and
(e2) discontinuing heating of said ambient air when the first temperature is equal to or greater than said pre-selected first temperature used in step (e1) or another pre-selected first temperature ranging from 1° C. to 10° C.

9. The method according to claim 1, wherein the heating step (e) is carried out to maintain the temperature of the heated air at or above a pre-selected air second temperature ranging from 10° C. to 20° C.

10. The method according to claim 1, wherein the cryogenic fluid is liquefied natural gas.

11. A method for converting a cryogenic fluid to gas in a regasification plant comprising a plurality of regasification units, each regasification unit comprising an ambient air heating zone and an air vaporizer comprising flow passages for passing said cryogenic fluid, said method comprising the following steps:
(1) operating a first subset of said plurality of the regasification units in a production mode, wherein said production mode for each regasification unit in the first subset comprises
(a) moving air in a downward manner through the vaporizer, said moved air externally contacting said flow passages and being in heat transfer relation with said flow passages;
(b) passing said cryogenic fluid through said flow passages of the vaporizer to vaporize said cryogenic fluid and to generate a gas; and
(2) operating a second subset of said plurality of the regasification units in a regenerative mode, wherein said regenerative mode for each regasification unit in the second subset comprises
(c) not passing said cryogenic fluid through said flow passages of the vaporizer;
(d) moving air in a downward manner with a forced air draft through the vaporizer, said moved air externally contacting said flow passages and being in heat transfer relation with said flow passages; and
(e) heating ambient air having a first temperature to form heated air having a second temperature, said step (e) being carrying out before said heated air is forcibly moved through the vaporizer.

12. The method according to claim 11, wherein each regasification unit comprises the apparatus of claim 20.

13. The method according to claim 11, wherein the air heating step (e) comprises:
(e1) heating said ambient air, when the first temperature is equal to or less a first pre-selected temperature which ranges from 0° C. to 10° C., to achieve a second temperature greater than said first temperature; and
(e2) discontinuing heating of said ambient air, when the first temperature is greater than said pre-selected first temperature used in step (e1) or another pre-selected first temperature which ranges from 1° C. to 10° C.

14. The method according to claim 11, wherein, when one vaporizer in production mode generates a gas in step (b) having an exit gas temperature lower than a predetermined exit gas temperature, the vaporizer is switched to regeneration mode by discontinuing step (b).

15. The method according to claim 14, wherein the predetermined exit gas temperature is between −40° C. and 30° C.

16. The method according to claim 11, wherein step (b) is performed at a pressure between 3.4 MPa and 18 MPa for the cryogenic fluid.

17. The method according to claim 1, wherein step (a) is carried out with a forced air draft.

18. The method according to claim 11, wherein the regeneration mode is carried out for a run time between 0.5 and 12 hours, and the production mode is carried out for a run time between 1 and 24 hours.

19. The method according to claim 1 1, wherein the cryogenic fluid is liquefied natural gas.

20. An apparatus for the conversion of cryogenic fluid to gas, said apparatus comprising:
an ambient air heating zone for forming heated air, said ambient air heating zone comprising a heating zone outlet;
a regulator device for intermittently operating said heating zone;
a vaporizer comprising a top end and flow passages for passing a cryogenic fluid therethrough, said top end of the vaporizer being in fluid communication with the heating zone outlet, said flow passages being in heat transfer relation with heated air; and
a forced draft device for forcibly moving air through the vaporizer, said forced draft device being in fluid communication with the vaporizer and disposed upstream of the vaporizer top end.

21. The apparatus according to claim 20, wherein the flow passages for passing a cryogenic fluid therethrough are pressure rated to allow the passing of the cryogenic fluid at a pressure between 3.4 MPa and 18 MPa.

22. The apparatus according to claim 20, wherein the regulator device is further connected to the vaporizer for cyclic operation of said vaporizer between a production mode and a regeneration mode.

23. The apparatus according to claim 20, wherein the air vaporizer comprises a cryogenic fluid valve for feeding said cryogenic fluid to said vaporizer and a gas valve for exiting said gas from said vaporizer, and further wherein said regulator device controls the actuation of either valve or both valves in a staggered fashion.

24. The apparatus according to claim 20, wherein the heating zone and the forced draft device are connected and in fluid communication.
